(19) United States
(12) Patent Application Publication
(10) Pub. No.: US 2023/0033585 A1
(43) Pub. Date: Feb. 2, 2023

(54) TAXATION ANALYSIS FOR PROPOSED TRANSACTIONS

(71) Applicant: Intuit Inc., Mountain View, CA (US)

(72) Inventor: Stephen H. Wright, Allen, TX (US)

(73) Assignee: Intuit Inc., Mountain View, CA (US)

(21) Appl. No.: 17/387,188

(22) Filed: Jul. 28, 2021

(51) Int. Cl. G06Q 40/00; G06Q 40/02; G06Q 40/04; G06F 9/54; H04L 29/06

(52) U.S. Cl. CPC G06Q 40/10; G06Q 40/123; G06Q 40/02; G06Q 40/04; G06F 9/541; H04L 63/126

(57) ABSTRACT

Systems and methods of taxation analysis for asset transactions are disclosed. A system may be configured to obtain data associated with a transaction to be executed, obtain a request to determine a tax implication of the transaction, generate a first tax return (with the transaction being excluded from use in generating the first tax return), and generate a second tax return based on the request (with the transaction being included for use in generating the second tax return). The system may also be configured to compare the first tax return and the second tax return, generate one or more results associated with the transaction based on the comparison, and provide the one or more results. The one or more results may indicate an impact on total taxes owed, deductions, loss of tax credits, or other impacts caused by the proposed transaction.

### TECHNICAL FIELD

This disclosure relates generally to taxation analysis for asset transactions, including determining the tax implications of proposed asset transactions for one or more users.

### DESCRIPTION OF RELATED ART

Various asset transactions may impact an individual or business tax return and thus the amount of taxes to be paid or returned to the individual after the tax year. For example, expenses of a business or a contractor during a tax year may impact deductions that may be claimed on that tax year's tax return for the business or contractor. In this manner, any type of asset transaction, such as buying goods, paying for services to upgrade a business, or buying or selling other types of assets, may impact the individual or business' tax return. In a specific example, online trading platforms exist to request execution of trades of various assets (such as stocks, bonds, mutual funds, cryptocurrency, and commodities). An individual may use his or her phone or computer to login to an investment platform to buy a desired asset or sell an asset currently owned.

Various tax preparation platforms exist to prepare and manage tax returns for users. For example, an individual may also use his or her phone or computer to login to a tax preparation software to prepare a tax return to be filed with a relevant tax agency. As noted above, each transaction (such as a trade via an online trading platform or buying or selling other types of assets) may impact the tax return and thus the amount of taxes to be paid or returned to the individual or business after the tax year.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter. Moreover, the systems, methods, and devices of this disclosure each have several innovative aspects, no single one of which is solely responsible for the desirable attributes disclosed herein.

One innovative aspect of the subject matter described in this disclosure can be implemented as a computer-implemented method for determining tax implications of an asset transaction. The example method includes obtaining data associated with a transaction to be executed for a first user. The example method also includes obtaining a request to determine a tax implication of the transaction. The example method further includes generating a first tax return for the first user, with the transaction being excluded from use in generating the first tax return. The example method also includes generating a second tax return for the first user based on the request, with the transaction being included for use in generating the second tax return. The example method further includes comparing the first tax return and the second tax return and generating one or more results associated with the transaction based on the comparison. The example method also includes providing the one or more results.

Another innovative aspect of the subject matter described in this disclosure can be implemented in a system for determining the tax implications of an asset transaction. An example system includes one or more processors and a memory storing instructions that, when executed by the one or more processors, cause the system to perform operations. The operations include obtaining data associated with a transaction to be executed for a first user. The operations also include obtaining a request to determine a tax implication of the transaction for the first user. The operations also include generating a first tax return for the first user, with the transaction being excluded from use in generating the first tax return. The operations also include generating a second tax return for the first user based on the request, with the transaction being included for use in generating the second tax return. The operations also include comparing the first tax return and the second tax return and generating one or more results associated with the transaction based on the comparison. The operations also include providing the one or more results.

Another innovative aspect of the subject matter described in this disclosure can be implemented as a computer-implemented method for indicating the tax implications of an asset transaction. The example method includes obtaining a request for tax analysis of a transaction to be executed for a first user. The example method also includes providing a call to a tax preparation platform to request a tax implication of the transaction. The tax implication is based on a comparison between a first tax return and a second tax return for the first user, the first tax return excludes the transaction, and the second tax return includes the transaction. The example method also includes obtaining one or more results associated with the tax implication of the transaction to be executed. The example method also includes providing an indication of the one or more results to the first user.

Another innovative aspect of the subject matter described in this disclosure can be implemented in a system for indicating the tax implications of an asset transaction. An example system includes one or more processors and a memory storing instructions that, when executed by the one or more processors, cause the system to perform operations. The operations include obtaining a request for tax analysis of a transaction to be executed for a first user. The operations also include providing a call to a tax preparation platform to request a tax implication of the transaction. The tax implication is based on a comparison between a first tax return and a second tax return for the first user, the first tax return excludes the transaction, and the second tax return includes the transaction. The operations also include obtaining one or more results associated with the tax implication of the transaction. The operations also include providing an indication of the one or more results to the first user.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example network of a requesting computing system and a responding computing system for determining the tax implications of an asset transaction, according to some implementations.

FIG. 2 shows an example system executing a tax preparation platform, according to some implementations.

FIG. 3 shows an example system executing an asset transaction platform, according to some implementations.

FIG. 4 shows an illustrative flow chart depicting an example operation for determining the tax implications of an asset transaction, according to some implementations.

FIG. 5 shows an illustrative flow chart depicting an example operation for indicating the tax implications of an asset transaction, according to some implementations.

FIG. 6 shows an example depiction of a graphical user interface (GUI) for requesting tax analysis for a potential trade, according to some implementations.

FIG. 7 shows an example depiction of a GUI including a tax analysis for a potential trade, according to some implementations.

Like numbers reference like elements throughout the drawings and specification.

### DETAILED DESCRIPTION

Implementations of the subject matter described in this disclosure may be used in taxation analysis for asset transactions, such as determining the tax implications of proposed asset transactions to be executed.

Many asset transactions may have tax implications for a user. For example, a lawn care company may wish to expand, and the company may need to buy additional lawn equipment to service more clients. Any lawn equipment bought may affect the company's deductions for its tax return prepared after the tax year. In another example, a travelling salesman may upgrade his or her vehicle to assist with work. Payment for any upgrades may impact the salesman's deductions for his or her tax return prepared after the tax year. In a further example, a person or business may trade stocks, bonds, cryptocurrency, or other assets that may have tax implications for the person or business. In the specific example of stock or equity trading, many individuals and businesses use a trading platform to manage an investment portfolio. For example, various investment firms provide an application, an online portal, or other means for a user to access his or her account and request one or more trades to be executed (such as buying and selling stocks, bonds, mutual funds, cryptocurrency, commodities, exchange traded funds, or options).

As used herein, a user may refer to a person, business, or other taxable entity or an agent of the taxable entity. An asset transaction (also referred to as a transaction) may refer to any form of economic transaction that may potentially have tax implications for a user. Example transactions include buying or selling goods or services for a business or for an individual's employment, buying or selling goods for which sales tax is not collected at the time of sale, buying or selling stocks or other equities, making a charitable donation, or receiving a large gift from an extended family member or business. To note, an asset may be anything of value to a user, such as a good, service, or equity. An asset may also be goodwill or other intangibles associated with donations or other forms of giving or receiving (such as funding a tax preferred retirement account, giving to a 501(c)(3) charity in the United States, etc.).

As noted above, an asset transaction may have tax implications for the user. For the example of equities trading, realized losses from buying and selling a stock can be included as a deduction for the current year's tax return. Conversely, realized gains from buying and selling a stock is included as income or capital gains for the current year's tax return. When a trade is executed, the gain or loss is known/realized, and the realized gain or loss is included in the income tax return for the user following the tax period. Typically, tax returns are prepared after the tax year (such as in approximately February to April 15 of the next calendar year for US tax returns), and all of the realized gains and losses from the tax year are included in the tax return. Since tax returns are typically prepared after the tax year, tax returns may be prepared, e.g., three to twelve months after a trade is executed.

Various tax related factors impact a user's decision to execute a transaction. For example, an individual may buy medical supplies to exhaust a health care spending account. A business may make improvements and other expenditures during a unusually profitable tax year to reduce the impact of increased taxes on the business for the tax year. An individual may fund an individual retirement account (IRA) if the money may be untaxed in the account.

For the specific example of equities trading, a stock may be sold to limit losses during a large decline in the stock price, may be sold to short a stock expected to decline in price, may be sold for profit taking purposes, or may be sold to rebalance a portfolio. Whether to execute a trade may be affected by the tax implication of the trade. For example, how much is to be paid in taxes on the realized gain may impact whether the user desires to execute the trade. In a specific example, the taxes may be reduced based on how long the asset is held (such as for less than a year, more than a year, or more than two years).

In an example of some tax implications of an asset transaction (such as a stock trade), income limits exist for some deductions and credits (such as for the student loan interest payment deduction or child tax credits for United States federal income tax returns). In this manner, executing a transaction may impact tax deductions or credits available to the user. Since tax returns are prepared at a much later time than when the transaction is executed, the impact of the transaction on the user's taxes is unknown until long after execution of the transaction.

Some platforms can attempt to estimate the taxes due that is associated with a transaction. For example, a trading platform can estimate taxes due on an estimated gain for a proposed trade based on an estimated tax bracket. The trading platform can ask the user to estimate the user's income or the user's tax bracket. The platform can then multiply the estimated gain by the tax rate associated with the income or tax bracket to estimate taxes due.

However, the estimated taxes may be incorrect based on incorrect assumptions as to the tax bracket or income. For example, the user may mistakenly overestimate or underestimate his or her income, or the user may not know or may incorrectly guess his or her tax bracket. As an alternative, the estimated income or tax bracket may be based on the user's previous tax year's income or tax bracket, but changes in user income or other financial events for the current tax year may cause the estimated taxes to be incorrect. For example, a recent salary increase, bonus, business expansion, or previous asset sale (such as selling an investment home) can significantly impact the user's income for the tax year, which may cause an incorrect tax estimate based on the previously estimated income or tax bracket for a proposed trade. Furthermore, estimating taxes owed based on a user estimated income or tax bracket does not account for possible changes to tax deductions, credits, or other impacts on taxes. For example, an increase in income from an asset sale may cause a user's income to pass a threshold to reduce or lose a tax credit for the user.

In addition, a user performing asset transactions at a brick and mortar store (such as buying goods for a business at a home improvement store) does not have the ability to determine the tax implications of an asset transaction before preparing a tax return at the end of the current tax period, much less before executing the transaction. Furthermore, online stores do not provide a means to determine the tax implications of an asset transaction for a user.

There is a need to determine the tax implications of an asset transaction in real-time based on income and other financial factors (such as previous asset transactions) from the current tax year. Many users use a tax preparation platform (such as a software program or online service) to prepare tax returns. The tax preparation platform may include (or be coupled to) bookkeeping, paycheck, or other accounting services to obtain and manage financial transactions that occur throughout a current tax year. For example, the tax preparation platform may include a record of paychecks received by the user during the current tax year, a record of previous asset transactions executed during the current tax year, and a record of holdover taxes paid from the previous tax year return. The tax preparation platform may determine a tax impact of a proposed asset transaction in real-time based on current tax year financial information for the user.

Various implementations of the subject matter disclosed herein provide one or more technical solutions to the technical problem of correctly estimating tax implications in real-time for proposed asset transactions (such as online equities trading). In some implementations, a system executing a tax preparation platform may obtain data associated with a transaction to be executed for a first user, obtain a request to determine a tax implication of the transaction, generate a first tax return for the first user (with the transaction being excluded from use in generating the first tax return), generate a second tax return for the first user based on the request (with the transaction being included for use in generating the second tax return), compare the first tax return with the second tax return, generate one or more results associated with the transaction based on the comparison, and provide the one or more results. In this manner, the system determines the tax implications of an asset transaction based on a difference between a first tax return generated without the proposed transaction and a second tax return generated with the proposed transaction. The tax returns may be based on current tax year financial transactions (such as an annual income estimated from year-to-date income) to provide a better estimate of taxes due as part of the one or more results. In addition, the one or more results may indicate other changes in the tax return (such as losing a tax credit or deduction, impact on holdover taxes, or a change in tax bracket based on the proposed trade) or recommendations to increase tax savings or reduce tax implications of a transaction to be executed. In this manner, more accurate and more comprehensive tax implications of a proposed asset transaction can be provided to a user before the transaction is executed.

Various aspects of the present disclosure provide a unique computing solution to a unique computing problem that did not exist prior to the use of computer implemented tax preparation platforms. Determining and indicating tax implications of a proposed asset transaction in real-time and within a user platform communicating with a tax preparation platform cannot be performed in the human mind, much less using pen and paper. As such, implementations of the subject matter disclosed herein are not an abstract idea such as organizing human activity or a mental process that can be performed in the human mind.

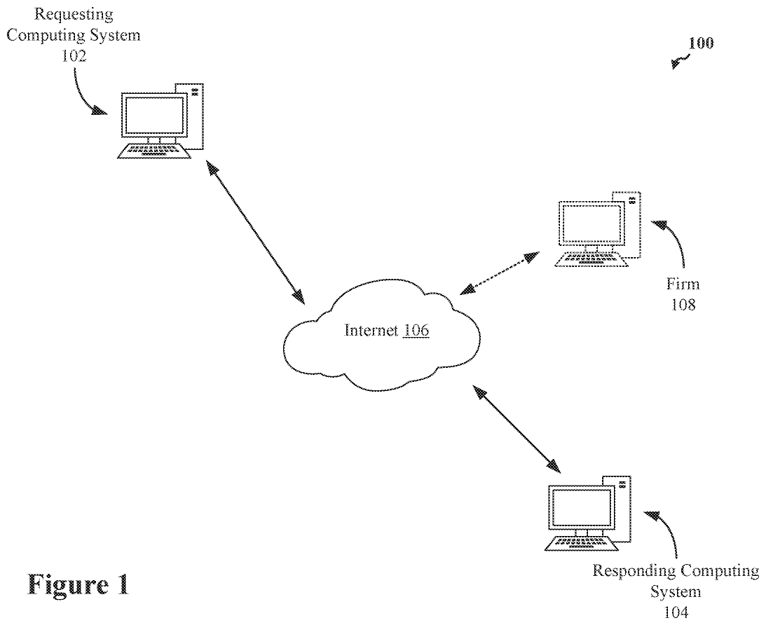

FIG. 1 shows an example network 100 of a requesting computing system 102 and a responding computing system 104 for determining the tax implications of an asset transaction, according to some implementations. The requesting computing system 102 may be a user's computing system executing an asset transaction platform. For example, the requesting computing system 102 may include a user desktop, laptop, smartphone, or tablet executing a transaction application.

A transaction application may be any suitable application to be executed by the system 102 to indicate the tax implications of a proposed transaction to the user. For example, for transactions from a brick and mortar store or other types of stores, the application may be provided by the tax preparation firm and linked to the user's account with the firm. The system 102 may communicate with the system 104 of the tax preparation firm via the internet 106 regarding a proposed transaction at the store (such as by a user scanning a universal product code (UPC) or otherwise indicating the products or services proposed to be bought or sold in the transaction). In another example, for online equities trades, the application may be an online trading application provided by an investment firm 108. The system 102 may communicate with an investment firm 108 (such as a server of the investment firm configured to executed trades on a publicly traded stock market) via the internet 106 in order to access the user's account and request one or more trades to be executed on the user's behalf.

The system 102 communicates with a responding computing system 104 via the internet 106. The responding computing system 104 includes a computing device, server, or other system executing a tax preparation platform (such as a tax preparation software application) to prepare tax returns and obtain and manage financial transactions for a current tax year for one or more users. When the system 102 receives a request for a proposed transaction from a user or a request to determine the tax implications of a proposed transaction (such as via a graphical user interface (GUI) for a trading platform on the system 102 and communicating with the firm 108, via a mobile application dedicated to indicating the tax implications of a proposed transaction in a brick and mortar store or service center, etc.), the system 102 may provide to the responding computing system 104 a request to determine the tax implications of the proposed transaction (and information regarding the proposed transaction). The system 104 determines the tax implications of the proposed transaction using the tax return preparation platform and responds to the request by providing one or more results to the system 102. For example, the system 104 may generate a first tax return for a user not including the proposed transaction, generate a second tax return for the user including the proposed transaction, and compare the first tax return and the second tax return to generate the one or more results. The first tax return and the second tax return can be based on the current tax year's financial transactions (such as year-to-date income based on paychecks and previous asset transactions for the tax year). Preparing the tax returns may also include analysis of the current tax year's financial transactions to previous tax years' transactions to determine a variance in income and other tax situations to impact the current tax year's tax return.

The one or more results may include one or more of:
a total tax value indicating a difference in total taxes owed by a user between the first tax return and the second tax return;
an indication as to an impact on itemized deductions to the user between the first tax return and the second tax return;
an indication as to whether the transaction would cause a change in tax brackets to the user;
an impact on prepaid taxes by the user;
a child tax credit value indicating a difference in child tax credit to be received by the user between the first tax return and the second tax return;
a student loan interest deduction value indicating a difference in student loan interest deductions available to the user between the first tax return and the second tax return; or
a health care deduction value indicating a difference in health care deductions available to the user between the first tax return and the second tax return.

The one or more results may also include one or more recommendations regarding possible actions to reduce the taxes owed or increase the taxes to be returned to the user. For example, if a healthcare spending account is exhausted for the tax year, the one or more results for a proposed transaction of buying medical supplies or having a non-emergency medical procedure performed may include a recommendation to wait until the next tax year when the healthcare spending account may be replenished.

After obtaining the one or more results, the system 102 indicates the one or more results to the user before the transaction occurs. For an online equities trade, the one or more results may be indicated to the user before the system 102 obtains confirmation from the user that the trade is to be executed. In this manner, the tax implications of a proposed transaction may be determined in real-time before the transaction is executed. Implementations of determining and indicating the tax implications of a proposed transaction are described in more detail below. While many of the examples below are with reference to online asset trading (such as for stocks, bonds, cryptocurrency, etc.) for clarity in explaining aspects of the present disclosure, the present disclosure is not limited to online asset trading. For example, the present disclosure covers other types of proposed transactions, such as for goods at brick and mortar stores, for services at a service center, for goods and services from an online store, etc.

While FIG. 1 depicts one system 102 in communication with system 104 for simplicity, any number of user systems may communicate with the system 104. For example, thousands or more users may have systems communicating with the system 104 executing the tax preparation platform to generate tax returns for the users and provide responses regarding the tax implications of various asset transactions to be executed for the users. As such, the system 104 may be configured to generate a large number of tax returns in real-time on any day in order to determine the tax implications of proposed transactions for each of the users.

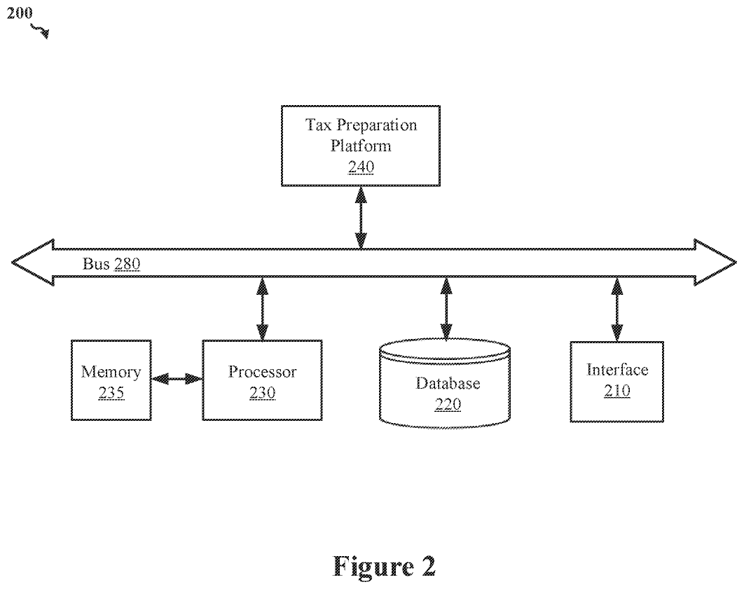

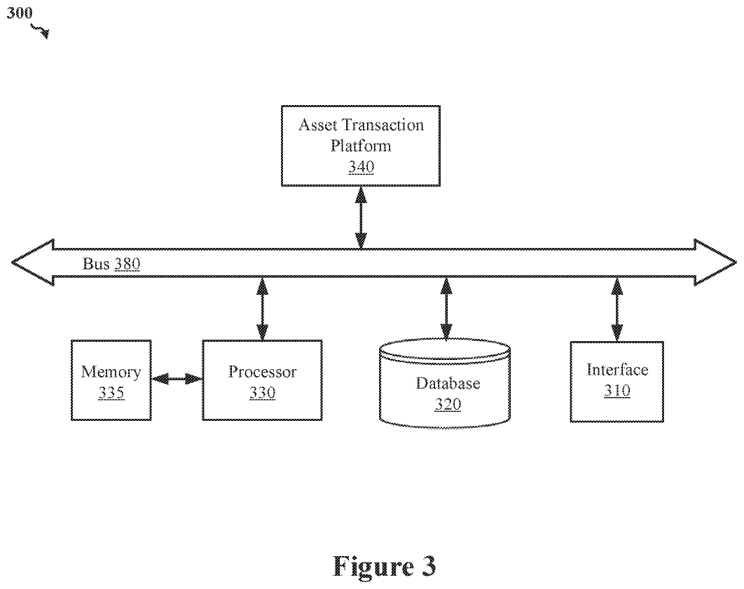

For clarity and simplicity in describing aspects of the present disclosure, the system executing the transaction platform (such as system 102) is depicted and described as a separate system from the system executing the tax return preparation platform (such as system 104). For example, system 200 in FIG. 2 may be an implementation of the system 104, and system 300 in FIG. 3 may be an implementation of the system 102. In some other implementations, the asset transaction platform and the tax return preparation platform may be executed on the same computing system. For example, a user's desktop may include a trading application to request and execute asset trades and may include a tax return preparation application to obtain records of a user's paychecks and previous transactions for the current tax year as well as prepare tax returns for the user. In this manner, the user's desktop may make calls and responses between the trading application and the return preparation application (such as via application programming interfaces (APIs) of the applications) in determining and indicating to the user the tax implications of a proposed trade.

While the system 102 is depicted as being a user system executing a transaction platform, in some other implementations, the transaction platform is executed by a system of another entity (such as an investment firm 108). For example, a user may use a website or online portal from system 102 to remotely access a trading platform at the firm 108. In this manner, proposed trades may be generated at the system of the firm 108 and communicated to the system 104 to determine the tax implications of the proposed trade. The system at the firm 108 may then obtain one or more results indicating the tax implications and provide an indication of the tax implication to the user via a website or online portal accessed by the system 102. Therefore, as used herein, a user system or a system executing or otherwise using a transaction platform may refer to a user's own computing system or a computing system of another entity executing the transaction platform (such as an investment firm or other financial institution executing a trading platform and performing operations on the user's behalf). While the examples are described below with reference to the separate systems 200 and 300, various embodiments of systems or system components are envisioned that may be used in performing aspects of the present disclosure (such as system 200 and system 300 being the same system or system 200 being another's system (such as an investment firm's system) instead of a user system).

FIG. 2 shows an example system 200 executing a tax preparation platform 240, according to some implementations. The system 200 is an example implementation of the system 104 in FIG. 1. The system 200 includes an interface 210, a database 220, a processor 230, a memory 235 coupled to the processor 230, and a tax preparation platform 240. In some implementations, the various components of the system 200 may be interconnected by at least a data bus 280, as depicted in the example of FIG. 2. In other implementations, the various components of the system 200 may be interconnected using other suitable signal routing resources.

The interface 210 may be one or more input/output (110) interfaces to receive input data to be used in generating one or more results associated with the tax implications of one or more proposed transactions for one or more users. For a proposed transaction for a first user, the interface 210 may obtain data associated with a transaction to be executed for the first user. For the purchase or sale of goods, example data may include the goods or services to be bought or sold, the estimated total of the transaction, or the type of goods/services being bought or sold (such as whether goods are medical or school supplies that may impact specific deductions or tax preferred accounts). For a stock or other equities trade to be executed, example data may include, e.g., the estimated total amount of a trade (such as the estimated amount of money to be received in selling a stock based on the current market price), length of time in owning an asset (which may impact how any gain once sold is taxed), the asset name (such as a stock symbol), or the amount to be traded (such as the number of shares to be bought or sold).

The interface 210 may also obtain a request to determine a tax implication of the transaction for the first user. In some implementations, obtaining the request includes obtaining the data implying a request to determine the tax implication, or the request is included in the data obtained. The obtained data and/or request may be obtained from the system executing the transaction platform (such as the system 102 in FIG. 1).

The interface 210 may also provide one or more results associated with the transaction and indicating the tax implications that are generated by the system 200. The interface 210 may also be used to provide or receive other suitable information, such as computer code for updating one or more programs stored on the system 200, information from investment firms or other systems for preparing tax returns for one or more users, etc. An example interface may include a wired interface or wireless interface to the internet or other means to communicably couple with user devices, financial institution devices (such as for one or more investment firms), or other suitable devices. For example, the interface 210 may include an interface with an ethernet cable (or a wireless interface) to a modem, which is used to communicate with an internet service provider (ISP) directing traffic to and from user devices, financial institutions, and/or other parties. The interface 210 may also be used to communicate with another device within the network to which the system 200 is coupled. As used herein for a system 200 remote to a user, communicating with a “user” or receiving/providing traffic from/to a “user” may refer to communicating with the user's device (such as a smartphone, tablet, personal computer, or other suitable electronic device) or another entity acting on the user's behalf (such as a financial institution, an online merchant at the direction of the user, etc.). The interface 210 may also include a display, a speaker, a mouse, a keyboard, or other suitable input or output elements that allow interfacing with the system 200 by a local user or moderator.

The database 220 may store the obtained data used to generate the one or more results. The database 220 may also store the one or more results generated by the system 200, the tax returns generated by the system 200, or other information of the system 200. In some implementations, the database 220 may include a relational database capable of presenting information as data sets in tabular form and capable of manipulating the data sets using relational operators. The database 220 may use Structured Query Language (SQL) for querying and maintaining the database 220.

The processor 230 may include one or more suitable processors capable of executing scripts or instructions of one or more software programs stored in system 200 (such as within the memory 235). For example, the tax preparation platform 240 may include a software application that is to be executed by the processor 230 to generate one or more tax returns and generate the one or more results associated with the tax implications of one or more proposed transactions. The processor 230 may include a general purpose single-chip or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. In one or more implementations, the processor 230 may include a combination of computing devices (such as a combination of a DSP and a microprocessor, a plurality of microprocessors, one or more microprocessors in conjunction with a DSP core, or any other such configuration).

The memory 235, which may be any suitable persistent memory (such as non-volatile memory or non-transitory memory) may store any number of software programs, executable instructions, machine code, algorithms, and the like that can be executed by the processor 230 to perform one or more corresponding operations or functions. For example, the tax preparation platform 240 may include a software application that is to be stored by the memory 235. In some implementations, hardwired circuitry may be used in place of, or in combination with, software instructions to implement aspects of the disclosure. As such, implementations of the subject matter disclosed herein are not limited to any specific combination of hardware circuitry and/or software.

The tax preparation platform 240 (also referred to as a tax return preparation platform) may include one or more software applications configured to generate one or more tax returns and to generate one or more results indicating the tax implications of one or more proposed transactions. In some implementations, the tax preparation platform 240 includes an API to allow the transfer of data between the tax preparation platform 240 and one or more other programs (such as a transaction platform). For example, an API may be used to allow ingestion of the data obtained via the interface 210 and to allow providing results generated by the tax preparation platform 240 to the interface 210 or another system component. In this manner, the data and the request may be received from an API of an asset transaction platform (such as a trading application or other suitable application) executed on a device on behalf of the user, and the one or more results may be provided to the API of the asset transaction platform.

In determining the tax implications of a proposed transaction for a user, the tax preparation platform 240 generates a first tax return excluding the proposed transaction and generates a second tax return including the proposed transaction. In some implementations, the first tax return and the second tax return are based on a projected income of the user for a current tax year based on income received to date for the current tax year. For example, the tax preparation platform 240 may be configured to generate tax returns (and determine the tax implications for transactions) for a plurality of users, and the system 200 may be communicably coupled to a plurality of user devices (such as via the internet). The system 200 may be configured to obtain records of current tax year income (such as copies of paychecks from a payroll service, previous asset transaction records from a transaction platform or an investment firm, etc.). The database 220 may include a record for each user aggregating the information of current tax year income, and may also include any other suitable information for each user (such as previous tax year information).

The system 200 accesses the user's record and uses the current tax year income information to generate the first tax return (excluding information from the proposed transaction). For example, the income received to date may be extrapolated to a projected income for the current tax year, and the projected income may be used to generate the first tax return. In another example, a deviation in the income received to date for a current tax year compared to income received to the same date for a previous tax year may be extrapolated to a full tax year to project a current tax year income as a deviation from the previous tax year income. The first tax return may also be based on deductions and credits claimed in one or more previous tax years, tax credits deferred from one or more previous tax years, taxes prepaid from a previous tax year, or other information collected for the user. The first tax return may also be based on previous asset transactions executed for the current tax year. For equities trading, previous asset transactions may refer to buying or selling an asset as well as the payment of dividends, disbursements, or other transactions for the asset that occurred. For other types of asset transactions, previous asset transactions may refer to buying or selling goods or services for a business, buying goods or services of a particular type or category (such as medical supplies, school supplies, etc.), or previous charitable donations.

The second tax return (including the proposed transaction) may be similarly generated as the first tax return, except that the proposed transaction is used in generating the second tax return. In this manner, the difference between the first tax return and the second tax return may be exclusively based on whether the proposed transaction is included for the tax return. The system 200 compares the first tax return and the second tax return and generates one or more results indicating the tax implications associated with the proposed transaction.

The one or more results may include any suitable indicators of the tax implications of the trade to be executed. For example, the one or more results may include one or more of:
a total tax value indicating a difference in total taxes owed by a user between the first tax return and the second tax return;
an indication as to an impact on itemized deductions to the user between the first tax return and the second tax return;
an indication as to whether the transaction would cause a change in tax brackets to the user;
an impact on prepaid taxes by the user;
a child tax credit value indicating a difference in child tax credit to be received by the user between the first tax return and the second tax return;
a student loan interest deduction value indicating a difference in student loan interest deductions available to the user between the first tax return and the second tax return; or
a health care deduction value indicating a difference in health care deductions available to the user between the first tax return and the second tax return.

The one or more results may also include one or more recommendations regarding possible actions to reduce the taxes owed or increase the taxes to be returned to the user. For example, if a healthcare spending account is exhausted for the tax year, the one or more results for a proposed transaction of buying medical supplies or having a non-emergency medical procedure performed may include a recommendation to wait until the next tax year when the healthcare spending account may be replenished. The recommendations may also include an indication as to whether a proposed transaction may increase the chances of an audit by the tax authority to receive the tax return for the user, an indication as to whether certain goods or services fall within specific category or type (such as whether certain medical supplies qualify for purchase using a healthcare spending account), or other suitable indications of the implications to a tax return to be provided to a relevant tax authority.

Each tax return may take time to be generated by the system 200, and as a tax return becomes more complicated, generating the tax return may take longer. In some implementations, the system 200 generates the first tax return before the request is obtained to determine the tax implications of a proposed transaction. For example, the system 200 may generate the first tax return periodically (such as after each business day, each night, or another suitable time interval). In this manner, the second tax return is generated after obtaining the request the tax implications of a proposed transaction, and the most recent first tax return is used to compare with the second tax return to determine the tax implications of the proposed transaction. In some implementations, the system 200 persists a predefined number of first tax returns (such as one, five (for a business week), or twenty (for approximately a business month)). In this manner, the system 200 may delete the oldest first tax return when generating a new first tax return.

Since the system 200 may be configured to generate tax returns for a large plurality of users, a first tax return may be generated periodically for the plurality of users. For example, after each business day or during each night, the system 200 may use the tax preparation platform 240 to generate a first tax return for each user based on current income to date and previous asset transactions for that particular user. Since the first tax return may be generated prior to receiving the request to determine the tax implications of a proposed transaction, the time to generate the one or more results is reduced since only the second tax return (including the proposed transaction) is to be generated after receiving the request in order to compare the first tax return and the second tax return. In addition, much of the preparation in generating the first tax return may be reused in generating the second tax return since the only addition from the first tax return is the proposed transaction to be executed. In this manner, the amount of time a user must wait to obtain an indication of the tax implications is reduced to improve the user experience.

In some other implementations, both the first tax return and the second tax return are generated after obtaining the request to determine the tax implication of a proposed transaction for a user.

The tax preparation platform 240 may be embodied in instructions that, when executed by the processor 230, cause the system 200 to perform operations associated with generating one or more results associated with the tax implications of one or more proposed transactions for one or more users. The instructions of the component 240 may be stored in memory 235, the database 220, or another suitable memory. The instructions may be in the Python programming language format or another suitable computer readable format for execution by the system 200 (such as by the processor 230). While the tax preparation platform 240 is depicted as a software application, the tax preparation platform 240 may be implemented in software, hardware, or a combination thereof.

FIG. 3 shows an example system 300 executing an asset transaction platform 340, according to some implementations. The system 300 is an example implementation of the system 102 in FIG. 1. The system 300 includes an interface 310, a database 320, a processor 330, a memory 335 coupled to the processor 330, and an asset transaction platform 340. In some implementations, the various components of the system 300 may be interconnected by at least a data bus 380, as depicted in the example of FIG. 3. In other implementations, the various components of the system 300 may be interconnected using other suitable signal routing resources.

The interface 310 may be one or more input/output (I/O) interfaces to provide a call to a tax preparation platform to request a tax implication of a transaction to be executed and to obtain one or more results associated with the tax implication of the transaction to be executed (such as described above with reference to the system 200 in FIG. 2). For a call regarding a proposed transaction for a user, the interface 310 may provide data associated with the transaction to be executed for the user. As noted above, example data may include the goods or services to be bought or sold, the types of goods or services, whether sales tax is to be collected at time of sale, etc. Example data for an equities trade may include, e.g., the estimated total amount of a trade (such as the estimated amount of money to be received in selling a stock based on the current market price), length of time in owning an asset (which may impact how any gain once sold is taxed), the asset name (such as a stock symbol), or the amount to be traded (such as the number of shares to be bought or sold). The data may be provided to the system executing the tax preparation platform (such as the system 104 in FIG. 1).

The interface 310 may also obtain (such as from a system 200 in FIG. 2) one or more results associated with the tax implication of the transaction to be executed. The interface 310 may also be used to provide or receive other suitable information, such as computer code for updating one or more programs stored on the system 300, information from investment firms or other systems, etc. For example, for equities trades, the interface 310 is configured to provide trade requests and confirmation of trades to be executed to an investment firm 108. In this manner, the firm 108 is communicated with via the interface 310 in obtaining information to generate a proposed trade request and provide information to the user regarding the proposed trade request (such as a symbol lookup, a stock price, a previous performance, a volatility, etc.). The interface 310 is then used to provide a request to the firm 108 to execute the proposed trade.

An example interface may include a wired interface or wireless interface to the internet or other means to communicably couple with tax preparation devices, financial institution devices (such as for one or more investment firms for equities trades), or other suitable devices. For example, the interface 310 may include an interface with an ethernet cable (or a wireless interface) to a modem, which is used to communicate with an internet service provider (ISP) directing traffic to and from financial institutions and/or other parties. The interface 310 may also be used to communicate with another device within the network to which the system 300 is coupled. The interface 310 may also include a display, a speaker, a mouse, a keyboard, or other suitable input or output elements that allow interfacing with a user. For example, the interface 310 may include a GUI on a display in order for a user to access one or more programs, including the asset transaction platform 340.

In some implementations, the asset transaction platform 340 may be an application executed by the system 300 and accessed by a user via a GUI of a display of the interface 310. In an example of determining a tax implication of a proposed purchase in a brick and mortar store, execution of the application may cause the system 300 to use a camera or scanner, to capture a UPC, a quick response (QR) code, or other identifying information of a good or service to be purchased. The GUI may also allow the user to manually enter information regarding the good or service, and/or the application may be configured to cause the system 300 to use a microphone to allow the user to audibly indicate information regarding the good or service.

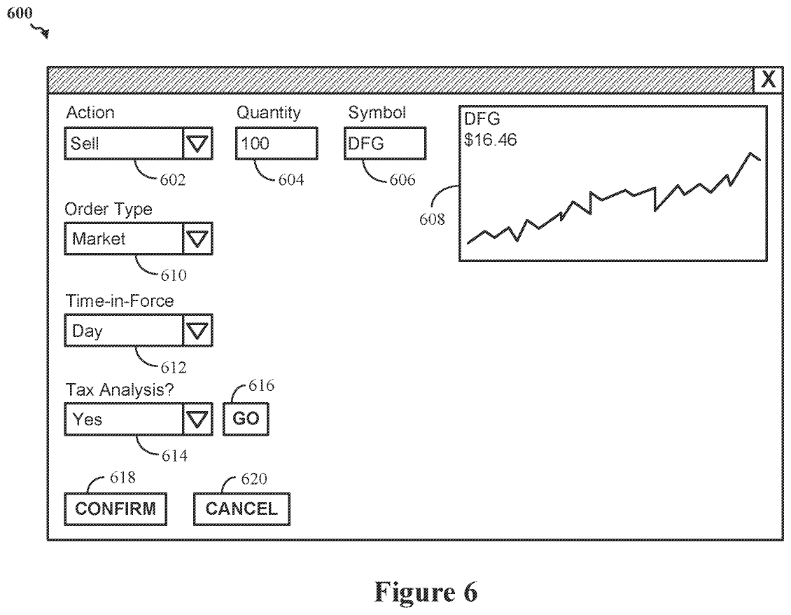

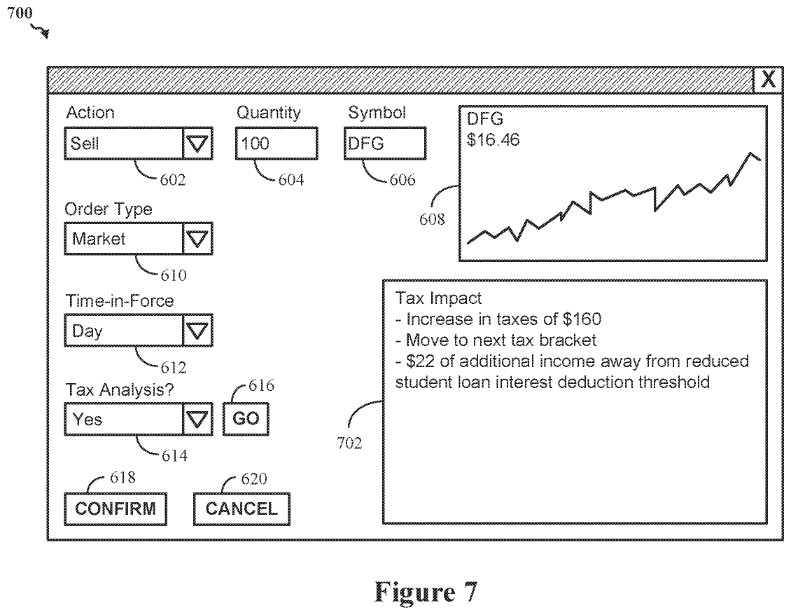

In a specific example for online equities trading, the asset trading GUI may be configured to integrate components for determining the tax implication of a proposed trade (such as described below with reference to FIGS. 6 and 7). For an online store, the store's webpage or mobile application may include integrated tax analysis components to allow a user to link his or her tax preparation account to his or her store account to allow the tax preparation platform to determine the tax implications of a transaction to be executed.

The database 320 may store any obtained or generated data for the asset transaction platform 340 (such as information for transactions to be executed, tax returns that may be obtained, one or more results indicating the tax implications of a transaction, and so on). The database 320 may also store other information of the system 300, such as records for the user, other applications, or other system information. In some implementations, the database 320 may include a relational database capable of presenting information as data sets in tabular form and capable of manipulating the data sets using relational operators. The database 320 may use Structured Query Language (SQL) for querying and maintaining the database 320.

The processor 330 may include one or more suitable processors capable of executing scripts or instructions of one or more software programs stored in system 300 (such as within the memory 335). For example, the asset transaction platform 340 may include a software application that is to be executed by the processor 330 to generate a proposed transaction to be executed, request the tax implications of the proposed transaction, and indicate the tax implications to the user. For equities trading, the software application may also be used to confirm that a trade is to be executed after indicating the tax implications. The processor 330 may include a general purpose single-chip or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. In one or more implementations, the processor 330 may include a combination of computing devices (such as a combination of a DSP and a microprocessor, a plurality of microprocessors, one or more microprocessors in conjunction with a DSP core, or any other such configuration).

The memory 335, which may be any suitable persistent memory (such as non-volatile memory or non-transitory memory) may store any number of software programs, executable instructions, machine code, algorithms, and the like that can be executed by the processor 330 to perform one or more corresponding operations or functions. For example, the asset transaction platform 340 may include a software application that is to be stored by the memory 335. In some implementations, hardwired circuitry may be used in place of, or in combination with, software instructions to implement aspects of the disclosure. As such, implementations of the subject matter disclosed herein are not limited to any specific combination of hardware circuitry and/or software.

The asset transaction platform 340 (also referred to as a trading platform) may include one or more software applications configured to generate one or more proposed transactions that may be executed, request and obtain indications of the tax implications of the proposed transactions, indicate the tax implications to the user, and optionally confirm or cancel a proposed transaction (such as for online store or online equities trading). In some implementations, the transaction platform 340 includes an API to allow the transfer of data between the tax preparation platform 240 and the transaction platform 340. For example, for equities trading, an API may be used to communicate with an investment firm 108 via the interface 310 to generate a proposed trade (including, e.g., an asset symbol, number of shares, type of action (sell, buy, etc.), type of order (such as a market order or a limit order), and any other suitable information). The API may also be used to provide a call via the interface 310 to the system 104 (such as system 200) requesting a tax analysis on the proposed trade and to obtain one or more results from the responding system indicating the tax implication. In this manner, data may be communicated using the API between the trading platform 340 of system 300 and the tax preparation platform 240 of system 200.

As noted above, the one or more results may include any suitable indicators of the tax implications of the transaction to be executed. For example, the one or more results may include one or more of:
a total tax value indicating a difference in total taxes owed by a user between the first tax return and the second tax return;
an indication as to an impact on itemized deductions to the user between the first tax return and the second tax return;
an indication as to whether the transaction would cause a change in tax brackets to the user;
an impact on prepaid taxes by the user;
a child tax credit value indicating a difference in child tax credit to be received by the user between the first tax return and the second tax return;
a student loan interest deduction value indicating a difference in student loan interest deductions available to the user between the first tax return and the second tax return; or
a health care deduction value indicating a difference in health care deductions available to the user between the first tax return and the second tax return.

The one or more results may also include one or more recommendations regarding possible actions to reduce the taxes owed or increase the taxes to be returned to the user. For example, if a healthcare spending account is exhausted for the tax year, the one or more results for a proposed transaction of buying medical supplies or having a non-emergency medical procedure performed may include a recommendation to wait until the next tax year when the healthcare spending account may be replenished. The recommendations may also include an indication as to whether a proposed transaction may increase the chances of an audit by the tax authority to receive the tax return for the user, an indication as to whether certain goods or services fall within specific category or type (such as whether certain medical supplies qualify for purchase using a healthcare spending account), or other suitable indications of the implications to a tax return to be provided to a relevant tax authority.

After the system 300 obtains the one or more results for a proposed transaction, the system 300 may provide an indication of the one or more results to the user. For example, a GUI or other user interface may be used to display the tax implications of a proposed transaction. An illustrative example with reference to equities trading of indicating the tax implication of a proposed trade is described below with reference to FIGS. 6 and 7. As noted herein, though, aspects of the present disclosure may be applied for any suitable asset transaction.

The asset transaction platform 340 may be embodied in instructions that, when executed by the processor 330, cause the system 300 to perform operations associated with indicating the tax implications of one or more proposed transactions to the user. The instructions of the component 340 may be stored in memory 335, the database 320, or another suitable memory. The instructions may be in the Python programming language format or another suitable computer readable format for execution by the system 300 (such as by the processor 330). While the asset transaction platform 340 is depicted as a software application, the asset transaction platform 340 may be implemented in software, hardware, or a combination thereof.

The particular architectures of the system 200 in FIG. 2 and the system 300 in FIG. 3 are but one example of a variety of different architectures within which aspects of the present disclosure may be implemented. For example, in other implementations, components of the system 200 may be included in the system 300, or components of the system 300 may be included in the system 200 (such as in a combined system). In some other implementations, the components of the system 200 and/or the system 300 may be distributed across multiple devices, may be included in fewer components, and so on. While the below examples of generating one or more results associated with a transaction and indicating the one or more results to indicate the tax implications of a transaction are described with reference to system 200 and system 300, any suitable system or plurality of systems may be used to perform the operations described herein. While not depicted in the systems described above, in some implementations, the system 300 may provide information regarding executed transactions to the system 200 for the user's records. In this manner, the executed transactions may be used in determining the tax implication of future proposed transactions.

As noted above, systems 200 and 300 may work in conjunction (or a single system may work) to indicate the tax implication of a proposed transaction in real-time for a user. In this manner, the user is apprised of any impacts on the user's taxes for the current tax year before the transaction is to be executed. The user may use such information to account for money to be set aside to pay for additional taxes, or the user may use such information to determine whether to continue with execution of the transaction.

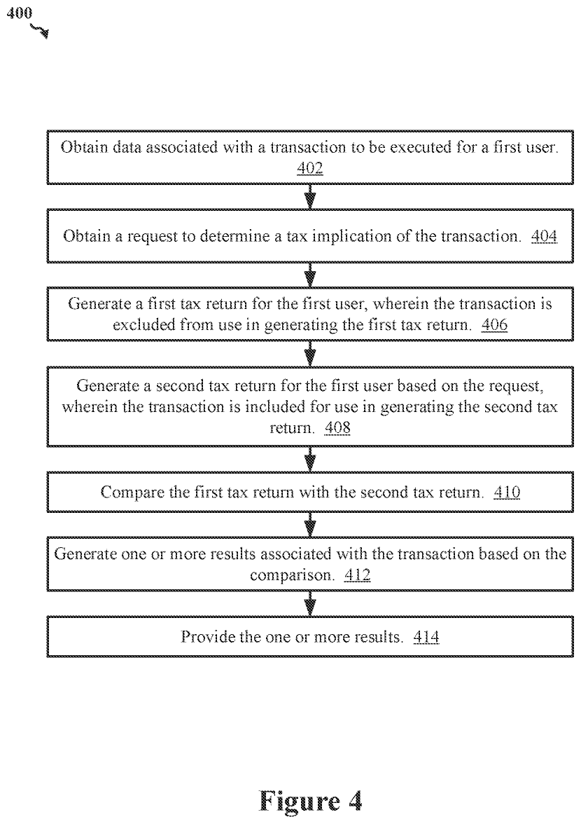

FIG. 4 shows an illustrative flow chart depicting an example operation 400 for determining the tax implications of an asset transaction, according to some implementations. The example operation 400 is described as being performed by the system 200 using the tax preparation platform 240 to determine the tax implication of a transaction potentially to be executed. At 402, the system 200 obtains data associated with a transaction to be executed for a first user. As noted above, the transaction to be executed may be a potential purchase of goods or services, a potential sale of goods or services, an equities trade, a charitable donation, etc. For an equities trade, example data may include, e.g., the estimated total amount of a trade (such as the estimated amount of money to be received in selling a stock based on the current market price), length of time in owning an asset (which may impact how any gain once sold is taxed), the asset name (such as a stock symbol), or the amount to be traded (such as the number of shares to be bought or sold). For a potential purchase of goods, example data may include, e.g., an identification of the goods, the number of units, the price per unit or total price, whether the price includes sales tax, whether sales tax is to be collected, etc. The data may be obtained via the interface 210 from a system executing the transaction platform (such as system 300), and the obtained data may be stored in the database 220 or another suitable memory of the system 200.

At 404, the system 200 obtains a request to determine a tax implication of the transaction. The system 200 may obtain any suitable trigger via the interface 210 from a system executing the transaction platform (such as system 300) to indicate that the system 200 is to determine the tax implication of the transaction. In some implementations, obtaining the data associated with the transaction includes an implicit request to determine the tax implications. In some other implementations, an explicit request may be included in the obtained data or may be obtained separate from the obtained data.

At 406, the system 200 generates a first tax return for the first user, wherein the transaction is excluded from use in generating the first tax return. In some implementations, the first tax return may be generated prior to obtaining the request. For example, the first tax return may be generated periodically (such as every business day). In some other implementations, the first tax return may be generated after obtaining the request.

At 408, the system 200 generates a second tax return for the first user, wherein the transaction is included for use in generating the second tax return. As noted above, the first tax return and the second tax return may be based on a projected income of the first user for a current tax year based on income received to date for the current tax year. The first tax return and the second tax return may also be based on one or more previous asset transactions for the current tax year (such as previously executed equities trades, dividends, or disbursements for one or more assets, the previous purchase or sale of goods or services, etc.). The second tax return may be generated using the same data as the first tax return except for the addition of the proposed transaction information.

At 410, the system 200 compares the first tax return with the second tax return. At 412, the system 200 generates one or more results associated with the transaction based on the comparison. If the first tax return is generated periodically, the system 200 uses the most recent first tax return to compare with the second tax return. The one or more results may indicate the difference between the first tax return and the second tax return and thus the tax implication of the proposed trade for the first user. In one example for the one or more values, the system 200 can compare the taxes due indicated by the first tax return to the taxes due indicated by the second tax return to determine a difference in total taxes owed. In another example, the system 200 can compare the itemized deductions on the first tax return to the itemized deductions on the second tax return to determine a difference in deductions and thus an impact on itemized deductions to the first user. In another example, the system 200 can compare the first user's determined tax bracket indicated in the first tax return to the first user's determined tax bracket indicated in the second tax return to determine whether the proposed trade would cause a change in tax brackets for the first user. In another example, the system 200 can compare the first tax return to the second tax return to determine an impact on prepaid taxes by the first user (such as the amount prepaid taxes would be reduced by the proposed trade). In another example, the system 200 can compare a child tax credit indicated on the first tax return to a child tax credit indicated on the second tax return to determine a difference in child tax credit to be received. In another example, the system 200 can compare a student loan interest deduction on the first tax return to a student loan interest deduction on the second tax return to determine a difference in student loan interest deduction to be received. In another example, the system 200 can compare a health care deduction indicated in the first tax return to the health care deduction indicated in the second tax return to determine a difference in health care deductions. Any other differences may be determined, such as a difference in business deduction. The comparison may be used to fill in each of the one or more results to be provided. The one or more results may also indicate any recommendations to reduce the tax burden or other suitable tax information to assist the user in determining whether to execute the transaction.

At 414, the system 200 provides the one or more results. For example, an API of the tax preparation platform 240 may be used by the system 200 to pass the one or more results via the interface 210 to the system 300, and the system 300 may indicate the tax implications to the user based on the one or more results. The one or more results may be included in any suitable data object, such as a JavaScript Object Notation (JSON) object readable by both the system 200 and the system 300. The data object may include defined values or indicators (such as a vector of values, binary flags, or other indicators) to be determined and provided to indicate defined aspects of the tax implications of the proposed transaction. The one or more results may include one or more of:
a total tax value indicating a difference in total taxes owed by a user between the first tax return and the second tax return;
an indication as to an impact on itemized deductions to the user between the first tax return and the second tax return;
an indication as to whether the trade would cause a change in tax brackets to the user;
an impact on prepaid taxes by the user;
a child tax credit value indicating a difference in child tax credit to be received by the user between the first tax return and the second tax return;
a student loan interest deduction value indicating a difference in student loan interest deductions available to the user between the first tax return and the second tax return; or
a health care deduction value indicating a difference in health care deductions available to the user between the first tax return and the second tax return.

The one or more results may also include one or more recommendations regarding possible actions to reduce the taxes owed or increase the taxes to be returned to the user. For example, if a healthcare spending account is exhausted for the tax year, the one or more results for a proposed transaction of buying medical supplies or having a non-emergency medical procedure performed may include a recommendation to wait until the next tax year when the healthcare spending account may be replenished. The recommendations may also include an indication as to whether a proposed transaction may increase the chances of an audit by the tax authority to receive the tax return for the user, an indication as to whether certain goods or services fall within specific category or type (such as whether certain medical supplies qualify for purchase using a healthcare spending account), or other suitable indications of the implications to a tax return to be provided to a relevant tax authority.

In this manner, the system 200 can determine the tax implications in real-time of a proposed transaction (e.g., in response to receiving a request to determine the tax implications) so that the user can be apprised of the tax implications via the transaction platform before confirming execution of the transaction. As noted above, the one or more results indicating the tax implication of a transaction to be executed may be provided from the system 200 to the system 300. The system 300 may then indicate to the user (such as via a GUI) the tax implication of the proposed transaction.

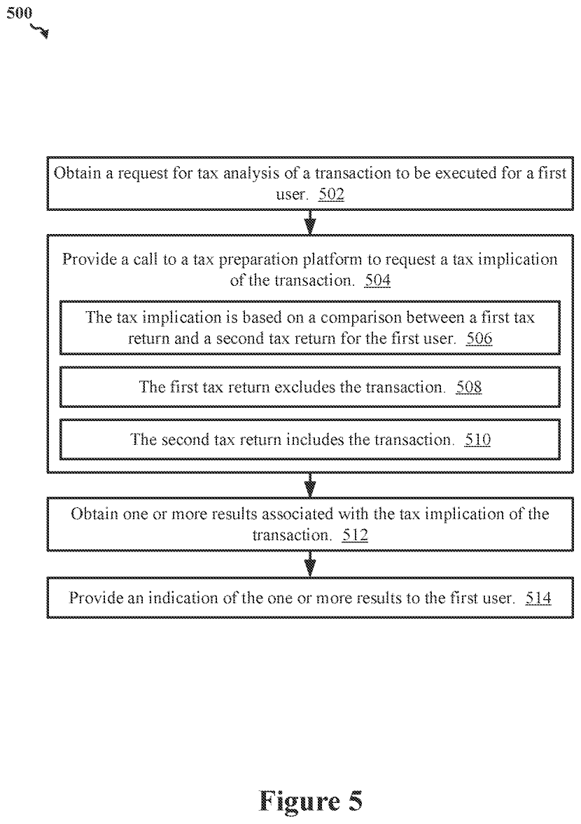

FIG. 5 shows an illustrative flow chart depicting an example operation 500 for indicating the tax implications of an asset transaction, according to some implementations. The example operation 500 is described as being performed by the system 300 using the transaction platform 340 to indicate the tax implication of a transaction potentially to be executed. At 502, the system 300 obtains a request for tax analysis of a transaction to be executed for a first user. For example, a user system may include a user interface (such as a GUI) for a user to input or otherwise indicate a proposed transaction. In another example, another entity's system may include an interface for receiving an indication of the proposed transaction (such as for an online store or some instances of equity trading). For a specific example regarding equities trading, an investment firm's system executing a trading platform may have a user propose a trade via an online portal or website accessed by the user's system. Alternatively, if the system 300 is the user's system for equities trading, the system 300 may communicate with the investment firm's system to generate a proposed trade. For example, the system 300 may use the investment firm's system to lookup a stock symbol based on a company name, obtain prior performance of the stock, obtain a current market price, or obtain other information to complete generating a proposed trade.

FIGS. 6 and 7 depict an example GUI for requesting and indicating the results of a tax analysis for a potential equities trade (such as a stock trade to be executed). While the examples described with reference to FIGS. 6 and 7 are regarding a potential stock trade for clarity in describing aspects of the present disclosure, the examples are envisioned to be extended to other types of potential asset transactions. As such, the present disclosure is not limited to the provided examples.

FIG. 6 shows an example depiction of a GUI 600 for requesting tax analysis for a potential trade, according to some implementations. The GUI 600 may be displayed by a display of the system 300. The GUI 600 as depicted is an example capture of a potential trade for stock “DFG” being generated so that tax analysis for the potential trade may be requested and performed. The GUI 600 may be part of an application or a website for the investment firm. If an application, the application may be for any suitable mobile or computer operating system. The GUI 600 includes various inputs to be obtained from the user. For example, the GUI 600 may include: an Action input 602 to indicate the type of trade to be performed (such as buying or selling); a Quantity input 604 to indicate how much (such as the number of shares) of an asset is to be bought or sold; a Symbol input 606 to indicate the symbol of the asset (such as a stock symbol) to be traded; an Order type input 610 to indicate the type of proposed trade (such as a market order or a limit order for buying or selling stock); and a Time-in-Force input 612 to indicate the length of time the trade request is to remain active before expiring without being filled (such as for the market day for a specific price to be met before being filled or for the order to expire).

Also as shown, the GUI 600 may include a window 608 to indicate a prior performance of the asset, a current price of the asset, or any other relevant information regarding the asset. The GUI 600 also includes a “Tax Analysis?” request input 614 where the user may indicate whether a tax analysis of a proposed trade is to be performed. The user pressing the GO button 616 is one implementation of the system 300 obtaining a request for a tax analysis of a trade. In some other implementations, the GUI 600 may be configured to always request a tax analysis for any proposed trade. In this manner, the act of a user proposing a trade may be an implementation of the system 300 obtaining a request for tax analysis of a transaction. For example, the user filling in the inputs of the GUI 600 (which may be without inputs 614 and 616) may be equivalent to the system 300 obtaining a request for tax analysis of the proposed trade.

The CONFIRM button 618 may be used by the user to request the proposed trade be executed by the investment firm 108. For example, in response to the user pressing the CONFIRM button 618, the system 300 may provide the trade request to the investment firm for execution. The CANCEL button 620 may be used by the user to prevent the proposed trade from being executed. For example, in response to the user pressing the CANCEL button 620, the proposed trade may be cleared from the asset trading platform 340 and the GUI 600 without providing a request to the investment firm that the trade be executed.

Referring back to FIG. 5, the system 300 provides a call to a tax preparation platform to request a tax implication of the transaction (504). For example, regarding a potential trade with reference to FIG. 6, in response to the user pressing the GO button 616 of the GUI 600 to request a tax analysis of the potential trade, the system 300 may provide a call to the system 200 requesting an indication of the tax implication of the proposed trade. As used herein, a transaction to be executed may refer to a proposed transaction or a potential transaction before execution. For example, a trade to be executed may be a potential trade before the trade is requested to be executed by an investment firm or another suitable broker. A trade to be executed may be cancelled or otherwise not provided to an investment firm for execution if desired by the user (such as by pressing the CANCEL button 620), or the trade may be requested to be executed (such as by pressing the CONFIRM button 618).

As noted above with reference to system 200 and example operation 400, the tax implication of a proposed transaction is based on a comparison between a first tax return and a second tax return for the first user (506). The first tax return excludes the proposed transaction (508). The second tax return includes the proposed transaction (510). The call may be via an API of the transaction platform to request information from the tax preparation platform. After requesting the tax implication information for the transaction, the system 300 waits for the information to be generated (such as described above as being performed by the system 200 performing the example operation 400 to generate and provide one or more results indicating the tax implication of a trade to be executed).

At 512, the system 300 obtains the one or more results associated with the tax implication of the transaction. The one or more results may be as described above as to be provided by the system 200. At 514, the system 300 provides an indication of the one or more results to the first user. In this manner, the system 300 may indicate the tax implication of the proposed transaction.

FIG. 7 shows an example depiction of a GUI 700 including the tax analysis 702 for a potential trade, according to some implementations. The GUI 700 is the same as the GUI 600 after requesting the tax analysis and indicating the tax implication of the proposed trade. While the tax analysis 702 is depicted as a window of the GUI 700, the tax analysis may be a separate pop-up window, an e-mail, an instant message, or other electronic notification means to indicate the tax implication of the proposed trade to the user. For other types of asset transactions, any suitable means of indicating the tax implication of the proposed transaction to the user may be used (such as via a mobile application, a webpage for an online store, etc.). In the example in FIG. 7, the tax implication of a proposed trade for a user includes a tax increase of $160, a move to a higher tax bracket, and approaching an income threshold for reducing student loan interest deductions. In this manner, the one or more results obtained by the system 300 may include a total tax value indicating the difference in taxes to be paid, an indicator of the change in tax brackets, and an indicator of the move towards the deduction threshold for student loan interest. The tax analysis 702 depicts an example of the one or more results. However, any suitable results may be determined an provided, such as described above.

With the user being provided the tax implication of the proposed transaction, the user is more informed as to whether the user wishes to proceed with executing the transaction, and the user is better prepared for any tax implications caused by an executed transaction (which may allow the user to plan for such tax implications before the tax returns are to be filed with the relevant tax authority). The user is also better informed of any tax implications to form the user's decision whether to continue with or prevent executing the proposed transaction (such as whether or not to buy goods or services, whether or not to execute a stock trade, etc.). Since the tax analysis may be performed in real-time with up to date income and other tax information, the user obtains more up-to-date, accurate, and detailed tax analysis of a proposed transaction as compared to estimating taxes owed based on a guessed tax bracket or other incomplete information. While not depicted in the example operation 500, the system 300 may provide information regarding transactions that are executed to the system 200. In this manner, the system 200 may use the additional transaction information to improve the tax returns generated for tax analysis.

As can be seen, the system 300 executing the transaction platform 340 may access the user's account for the tax preparation platform 240 executed on the system 200 or otherwise request information from the user's account regarding tax preparation that may be privileged or otherwise sensitive. In some implementations, the system 300 may obtain a user verification information from the first user, and the system 300 may provide the user verification information to the tax preparation platform 240 to verify that the first user is requesting the tax analysis. For example, the GUI 600 may be configured to request a username and password, a fingerprint, or other account verification information for the user's account on the tax preparation platform 240. The user verification information may be sent before or with requesting the tax analysis. In this manner, the system 200 verifies the user before determining the tax implication and providing an indication of the tax implication for a trade to the system 300. In another example, an online store may request and store user verification information for his or her tax preparation account to link such account with the user's profile for the online store. In this manner, a tax implication of a potential transaction at the online store may be determined and indicated before the user completes the transaction. In another example, a mobile application configured for the tax preparation platform and the user may store user verification information for the user's tax preparation account. In this manner, the mobile application may be used to request and indicate the tax implications of a potential transaction at a brick and mortar store or for other types of transactions. In some implementations, the verification information may be requested once and stored on the system 300. The verification information may then be provided from memory for each call to request tax analysis for a transaction for the user. Other security measures may be taken, and the present disclosure is not limited to the provided examples. For example, a user may be required to opt-in in his or her tax return preparation account to allow access to the account by third parties (including the transaction platform). In another example, the system 300 may be configured to perform a bot versus human verification test to verify a person is requesting tax analysis.

As used herein, a phrase referring to “at least one of” or “one or more of” a list of items refers to any combination of those items, including single members. As an example, “one or more of: a, b, or c” is intended to cover: a, b, c, a-b, a-c, b-c, and a-b-c.

The various illustrative logics, logical blocks, modules, circuits, and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices such as, for example, a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. For example, while a taxation period is described as a tax year, any periodic amount of time of one or more calendar years to be covered by a single tax return may be used (such as quarterly or semiannually). A tax year may refer to any suitable portion from one or more calendar years (such as a calendar quarter, fiscal quarter, etc.). In another example, while the figures and description depict an order of operations in performing aspects of the present disclosure, one or more operations may be performed in any order or concurrently to perform the described aspects of the disclosure. In addition, or to the alternative, a depicted operation may be split into multiple operations, or multiple operations that are depicted may be combined into a single operation. Thus, the claims are not intended to be limited to the implementations shown herein but are to be accorded the widest scope consistent with this disclosure, the principles and the novel features disclosed herein.

What is claimed is:

1. A computer-implemented method for determining tax implications of an asset transaction, comprising:
obtaining data associated with a transaction to be executed for a first user;
obtaining a request to determine a tax implication of the transaction;
generating a first tax return for the first user, wherein the transaction is excluded from use in generating the first tax return;
generating a second tax return for the first user based on the request, wherein the transaction is included for use in generating the second tax return;
comparing the first tax return with the second tax return;
generating one or more results associated with the transaction based on the comparison; and
providing the one or more results.

2. The method of claim 1, wherein the first tax return and the second tax return are based on a projected income of the first user for a current tax year based on income received to date for the current tax year.

3. The method of claim 1, wherein the first tax return and the second tax return are based on one or more previous transactions for a current tax year.

4. The method of claim 1, wherein generating the one or more results includes generating one or more of:
a total tax value indicating a difference in total taxes owed by the first user between the first tax return and the second tax return;
an indication as to an impact on itemized deductions to the first user between the first tax return and the second tax return;
an indication as to whether the transaction would cause a change in tax brackets to the first user;
an impact on prepaid taxes by the first user;
a child tax credit value indicating a difference in child tax credit to be received by the first user between the first tax return and the second tax return;
a student loan interest deduction value indicating a difference in student loan interest deductions available to the first user between the first tax return and the second tax return; or
a health care deduction value indicating a difference in health care deductions available to the first user between the first tax return and the second tax return.

5. The method of claim 1, further comprising generating the first tax return includes periodically generating the first tax return, wherein a most recent first tax return is used to compare with the second tax return.

6. The method of claim 5, wherein periodically generating the first tax return includes generating the first tax return for each business day.

7. The method of claim 1, wherein:
the transaction is an asset trade to be executed via an asset trading platform executed on a device on behalf of the first user;
the data and the request are received from an application programming interface (API) of the asset trading platform; and
the one or more results are provided to the API of the asset trading platform.

8. A system for determining tax implications of an asset transaction, the system comprising:
one or more processors; and
a memory storing instructions that, when executed by the one or more processors, causes the system to perform operations comprising:
obtaining data associated with a transaction to be executed for a first user;
obtaining a request to determine a tax implication of the transaction;
generating a first tax return for the first user, wherein the transaction is excluded from use in generating the first tax return;
generating a second tax return for the first user based on the request, wherein the transaction is included for use in generating the second tax return;
comparing the first tax return with the second tax return;
generating one or more results associated with the transaction based on the comparison; and
providing the one or more results.

9. The system of claim 8, wherein the first tax return and the second tax return are based on a projected income of the first user for a current tax year based on income received to date for the current tax year.

10. The system of claim 8, wherein the first tax return and the second tax return are based on one or more previous transactions for a current tax year.

11. The system of claim 8, wherein generating the one or more results includes generating one or more of:
a total tax value indicating a difference in total taxes owed by the first user between the first tax return and the second tax return;
an indication as to an impact on itemized deductions to the first user between the first tax return and the second tax return;
an indication as to whether the trade would cause a change in tax brackets to the first user;
an impact on prepaid taxes by the first user;
a child tax credit value indicating a difference in child tax credit to be received by the first user between the first tax return and the second tax return;
a student loan interest deduction value indicating a difference in student loan interest deductions available to the first user between the first tax return and the second tax return; or
a health care deduction value indicating a difference in health care deductions available to the first user between the first tax return and the second tax return.

12. The system of claim 8, wherein generating the first tax return includes periodically generating the first tax return, wherein a most recent first tax return is used to compare with the second tax return.

13. The system of claim 12, wherein periodically generating the first tax return includes generating the first tax return for each business day.

14. The system of claim 8, wherein:
the transaction is an asset trade to be executed via an asset trading platform executed on a device on behalf of the first user;
the data and the request are received from an application programming interface (API) of the asset trading platform; and
the one or more results are provided to the API of the asset trading platform.

15. A system for determining tax implications of an asset transaction, the system comprising:
one or more processors; and
a memory storing instructions that, when executed by the one or more processors, causes the system to perform operations comprising:
obtaining a request for tax analysis of a transaction to be executed for a first user;
providing a call to a tax preparation platform to request a tax implication of the transaction, wherein:
the tax implication is based on a comparison between a first tax return and a second tax return for the first user;
the first tax return excludes the transaction; and
the second tax return includes the transaction;
obtaining one or more results associated with the tax implication of the transaction; and
providing an indication of the one or more results to the first user.

16. The system of claim 15, wherein the first tax return and the second tax return are based on a projected income of the first user for a current tax year based on income received to date for the current tax year.

17. The system of claim 15, wherein the one or more results includes one or more of:
a total tax value indicating a difference in total taxes owed by the first user between the first tax return and the second tax return;
an indication as to an impact on itemized deductions to the first user between the first tax return and the second tax return;
an indication as to whether the transaction would cause a change in tax brackets to the first user;
an impact on prepaid taxes by the first user;
a child tax credit value indicating a difference in child tax credit to be received by the first user between the first tax return and the second tax return;
a student loan interest deduction value indicating a difference in student loan interest deductions available to the first user between the first tax return and the second tax return; or
a health care deduction value indicating a difference in health care deductions available to the first user between the first tax return and the second tax return.

18. The system of claim 15, wherein:
the first tax return is periodically generated; and
the second tax return is generated in response to the call requesting the tax implication.

19. The system of claim 15, wherein the operations further comprise obtaining a request from the first user to determine the tax implication of the transaction, wherein providing the call to the tax preparation platform is based on obtaining the request from the first user to determine the tax implication of the transaction.

20. The system of claim 15, wherein the operations further comprise:
obtaining user verification information from the first user; and
providing the user verification information to the tax preparation platform to verify that the first user is requesting the tax analysis.
